(19) United States
(12) Patent Application Publication
(10) Pub. No.: US 2022/0250034 A1
(43) Pub. Date: Aug. 11, 2022

(54) PARTICULATE CARBONACEOUS SORBENT MATERIALS AND METHOD OF USING SUCH SORBENT MATERIALS TO TREAT CONTAMINATED AQUATIC SEDIMENTS

(71) Applicant: ADA Carbon Solutions, LLC, Littleton, CO (US)

(72) Inventors: Micala Mitchek, Denver, CO (US); Joseph M. Wong, Castle Pines, CO (US)

(21) Appl. No.: 17/669,109

(22) Filed: Feb. 10, 2022

Related U.S. Application Data
(60) Provisional application No. 63/148,044, filed on Feb. 10, 2021.

(51) Int. Cl. B01J 20/28; B01J 20/20

(52) U.S. Cl. CPC B01J 20/28016; B01J 20/28004; B01J 2220/4837; B01J 20/28011; B01J 20/28071; B01J 20/20

(57) ABSTRACT

Disclosed herein are dual-form particulate carbonaceous sorbent compositions and methods of using such compositions to treat contaminated aquatic sediments. The dual-form particulate carbonaceous sorbent compositions may be deposited on a contaminated aquatic sediment in granular form to form an active barrier capping layer on the surface of the contaminated sediment, but then the sorbent composition undergoes particle size attrition within the active barrier capping layer thereby improving the adsorption kinetics and/or capacity of the sorbent material.

### CROSS REFERENCE TO RELATED APPLICATIONS

This application claims priority and the benefit under 35 U.S.C. § 119(e) to U.S. Provisional Application Ser. No. 63/148,044, filed on Feb. 10, 2021, which is incorporated by reference in its entirety.

### FIELD

The disclosure generally relates to particulate carbonaceous sorbent compositions and methods of using such sorbent compositions to treat contaminated aquatic sediments.

### BACKGROUND

Discharge of contaminants to aquatic environments can result in the contamination of the underlying sediments. Typical contaminants can include petroleum products, polychlorinated biphenyls (PCBs), polycyclic aromatic hydrocarbons (PAHs), dioxins, metals (mercury, copper, cadmium, lead, nickel, zinc, tin, etc.), radionuclides, and excess nutrients. Most of these contaminates, are long-lived and can pose health risks to humans and other organisms. A variety of methods exist for remediating contaminated sediments, including natural recovery, removal, in situ treatment, and capping, or a combination of methods.

Capping remediation methods are advantageous in that these methods are relatively low in cost, they have a relatively lower environmental impact during implementation, and the ability to rapidly reduce risks that result from the contamination. Capping methods involve covering contaminated sediments, in place, to provide a barrier layer between the contaminated sediment and the overlying aquatic ecosystem. Materials used to cap contaminated sediments can be inert or chemically and/or biologically active. Active caps, in addition to providing a physical barrier, effectively treat and/or remove contaminants that migrate from the underlying sediment into the active capping layer. The specific process by which contaminant treatment occurs depends upon the type of reactive material included as well as the contaminant(s) targeted for treatment.

Activated carbon has a strong affinity for a wide range of contaminants and has been used to treat air discharges, potable water, wastewater, and groundwater, among other things. Activated carbon is potentially an effective material for the active treatment of contaminated sediments. Activated carbon may be used alone, or with other materials in capping methods, or it may be mixed with or incorporated into the sediment layer (in situ treatment).

### SUMMARY

An aspect of the disclosure relates to methods for treating contaminated aquatic sediments using a dual-form particulate sorbent composition. The methods can comprise, providing a dual-form particulate sorbent composition comprising activated carbon, and dispersing the dual-form particulate sorbent composition at or near the surface of a body of water overlaying a contaminated sediment. In some applications, the dispersed particulate sorbent composition sinks and forms an active barrier layer over at least part of a surface of the contaminated sediment. The particulate sorbent composition that is contained in the active barrier layer undergoes particle attrition, and the particulate sorbent composition in the active barrier layer traps and/or sequesters at least a portion of one or more sediment-borne contaminates.

In some embodiments, the method can comprise providing a dual-form particulate sorbent composition comprising activated carbon, wherein the particulate sorbent composition is in the form of granules having a first particle size distribution with a first medium particle size distribution defined by first D10, D50, D90, mean, and mode values; and dispersing the dual-form particulate sorbent composition at or near the surface of a body of water overlaying a contaminated sediment. In some applications, the dispersed particulate sorbent composition sinks and forms an active barrier layer over at least part of a surface of the contaminated sediment. The particulate sorbent composition that is contained in the active barrier layer undergoes particle attrition resulting in a second particle size distribution defined by second D10, D50, D90, mean, and mode values, each second D10, D50, D90, mean, and mode value is no more than about 50% of each first D10, D50, D90, mean, and mode value, respectively.

In some embodiments, the method can comprise providing a dual-form particulate sorbent composition comprising activated carbon, wherein at least about 75% of the activated carbon is in the form of granules having one or more of a ball pan hardness of at least about 40% and no more than about 70%, an iodine number ranging from about 450 to about 650, and a molasses number ranging from about 25 to about 150; and dispersing the dual-form particulate sorbent composition at or near the surface of a body of water overlaying a contaminated sediment. In some applications, the dispersed particulate sorbent composition sinks and forms an active barrier layer over at least part of a surface of the contaminated sediment and the particulate sorbent composition in the active barrier layer traps and/or sequesters at least a portion of one or more sediment-borne contaminates.

Another aspect of the disclosure relates a dual-form particulate sorbent composition, that can be particularly suitable for use in forming an active barrier layer to treat contaminated aquatic sediments.

Yet, another aspect of the disclosure relates to methods of making a dual-form particulate sorbent composition, that can be particularly suitable for use in forming an active barrier layer to treat contaminated aquatic sediments.

Yet, another aspect of the disclosure relates to an active barrier layer formed on the surface of a contaminated sediment, the active barrier layer comprising the dual-form particulate sorbent composition.

In any of the above embodiments, the method can further comprise mixing the particulate sorbent composition with an inert material prior to the dispersing.

In these any of the embodiments, the particulate sorbent composition can further be in the form of granules having a first particle size distribution with a first medium particle size distribution defined by first D10, D50, D90, mean, and mode values, wherein the particulate sorbent composition that is contained in the active barrier layer undergoes particle attrition resulting in a second particle size distribution defined by second D10, D50, D90, mean, and mode values, each second D10, D50, D90, mean, and mode value being no more than about 50% of each first D10, D50, D90, mean, and mode value, respectively, and the dual-form particulate sorbent composition can comprises more than about 50 wt. % activated carbon, and at least most of the activated carbon can have one or more of an apparent density ranging from about 0.2 g/cc to about 0.4 g/cc, a specific gravity of greater than 1, wherein the first D50 value ranges from about 0.42 to about 1.7 mm.

In any of the embodiments, the particulate sorbent composition can further comprise more than about 50 wt. % activated carbon, and at least most of the activated carbon can have one or more of a ball pan hardness value of no more than about 75% and at least about 40%, an apparent density ranging from about 0.2 g/cc to about 0.4 g/cc, a specific gravity of greater than 1, an iodine number ranging from about 450 to about 650, a molasses number ranging from about 25 to about 150, wherein the first D50 value ranges from about 0.42 mm to about 1.7 mm.

In any of the embodiments, at least most of the particulate sorbent composition can have a ball pan hardness of between about 40% and 70% and an abrasion number ranging from about 40 to about 70.

In any of the embodiments, at least about 90% of the activated carbon can have a ball pan hardness of between about 40% and 70%, an iodine number ranging from about 475 to about 625, and a molasses number ranging from about 30 to about 120.

In any of embodiments, the particulate sorbent composition can comprises more than about 75 wt. % activated carbon, and at least most of the activated carbon can have one or more of a ball pan hardness value of no more than about 65% and at least about 45%, an apparent density ranging from about 0.2 g/cc to about 0.4 g/cc, a specific gravity of greater than 1, an iodine number ranging from about 475 to about 625, and a molasses number ranging from about 30 to about 120, and wherein the first particle size distribution is a 12×40 mesh size or a 20×50 mesh size.

In any of the embodiments, the particulate sorbent composition can comprise more than about 50 wt. % of an activated carbon, and at least most of the activated carbon can be the form of free flowing granules having a ball pan hardness of at least about 40% and no more than about 70%, a D50 size ranging from about 50 μm to about 2,000 μm, an apparent density of at least about 0.2 g/cc and no more than about 0.4 g/cc, an iodine number of at least about 450 and no more than about 650, and a molasses number of at least about 25 to about 150, and a specific density of more than 1.

In any of the embodiments, at least most of the activated carbon can have a D10 size ranging from about 50 μm to about 2,000 μm and/or a D90 size ranging from about 50 μm to about 2,000 μm.

In any of the embodiments, at least most of the activated carbon can be produced from sub-bituminous coal, lignite coal, or wood.

In any of the embodiments, at least most of the activated carbon can be produced from lignite coal.

In any of the embodiments, the dual-form particulate sorbent is substantially free of a binder and thermal derivative thereof.

In any of the embodiments, particle attrition can occur as a result of mechanical action at or near the surface of the contaminated sediment.

In any of the embodiments, the particulate sorbent composition can further comprise a water-soluble binder material and at least a portion of the water-soluble binder material dissolves in the body of water resulting in the particle attrition.

In any of the embodiments, the particulate sorbent composition can further from about 0.1 wt. % to about 30 wt. % of the water-soluble binder.

In any of the embodiments, at least most of the particulate sorbent composition can have an apparent density of between about 0.2 g/cc and 0.4 g/cc.

In any of the embodiments, at least most of the activated carbon can have a ratio of micropore volume to total pore volume ranging from about 0.2 to about 0.4 and ratio of macropore volume to total pore volume ranging from about 0.6 to about 0.8.

In any of the embodiments, the particulate sorbent can comprise one or more of a dopant to increase an ability of the particulate sorbent to adsorb a selected contaminant, a dispersant, and a flocculant.

In any of the embodiments, the contaminated sediment can be located at the bottom of a lake, a river, a stream, or an estuary.

In any of the embodiments, the active barrier can have a thickness from about 1 inch to about 6 inches.

In any of the embodiments, the sediment-born contaminate can selected from the group consisting of petroleum products, polychlorinated biphenyls (PCBs), polycyclic aromatic hydrocarbon (PAHs), dioxins, metals, radionuclides, excess nutrients, and a combination thereof.

### FIGURES

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 illustrates a flow sheet for the manufacture of the particulate sorbent composition in accordance with an embodiment of the present disclosure.

FIG. 2A is a drawing showing a method of capping a contaminated sediment in accordance with an embodiment of the present disclosure; and FIG. 2B is a drawing showing an active capping layer comprising the particulate sorbent composition formed on the surface of a contaminated sediment in accordance with an embodiment of the present disclosure.

FIG. 3 is a representative plot showing the shift in the initial particle size distribution of the particulate sorbent composition, after being subjected to particle size attrition.

FIG. 4A is a plot of the particle size distribution of an industry standard bituminous GAC before and after being subjected to simulated sediment conditions (“pre-placement test”, black and “post placement test”, grey bars, respectively); and FIG. 4B is a plot of the particle size distribution of a lignite based GAC (sample D) before and after being subjected to simulated sediment conditions (“pre-placement test”, black and “post placement test”, grey bars, respectively).

FIG. 5A is a plot of the particle size distribution of an industry standard bituminous GAC (black solid line) and several lignite based GACs (sample A (grey dashed line), sample B (grey solid line), sample C (black dashed line), and sample D (black dotted line)) before being subjected to simulated sediment conditions (“pre-placement test”); and FIG. 5B is a plot of the particle size distribution of an industry standard bituminous GAC (black solid line) and several lignite based GACs (sample A (grey dashed line), sample B (grey solid line), sample C (black dashed line), and sample D (black dotted line)) after being subjected to simulated sediment conditions (“post placement test”).

### DETAILED DESCRIPTION

### Definitions

“Abrasion number” refers to the ability of carbon to withstand handling and slurry transfer. Two different tests are used, based on the type of carbon material. A Ro-Tap abrasion test is used for bituminous-coal-based GAC and a stirring abrasion test is used for the softer, lignite-coal-based GAC. The abrasion number is the ratio of the final average (mean) particle diameter to the original mean particle diameter (determined by sieve analyses)×100.

“Absorption” refers to the incorporation of a substance in one state into another of a different state (e.g., liquids being absorbed by a solid or gases being absorbed by a liquid). Absorption is a physical or chemical phenomenon or a process in which atoms, molecules, or ions enter some bulk phase—gas, liquid, or solid material. This is a different process from adsorption, defined herein, since molecules undergoing absorption are taken up by the volume, not by the surface (as in the case for adsorption).

“Adsorption” refers to the adhesion or strong affinity of atoms, ions, biomolecules, or molecules of gas, liquid, or dissolved solids to a surface. This process creates a film of the adsorbate (the molecules or atoms being accumulated) on the surface of the adsorbent. The exact nature of the bonding depends on the details of the species involved, but the adsorption process is generally classified as physisorption (characteristic of van der Waals or capillary adsorption forces) or chemisorption (characteristic of covalent bonding). It may also occur due to electrostatic attraction.

“Apparent density” refers to the mass (weight) of a quantity of carbon divided by the volume it occupies. The total volume includes the particle volume, inter-particle void volume, and internal pore volume.

“Ball pan hardness” refers to a method for determining the hardness of a bulk particulate material. The method is performed according to ASTM D3802. In this method, a screened, weighed sample of a particulate material (e.g., carbon) is placed in a special hardness pan with a number of stainless-steel balls and subjected to rotation and tapping action for thirty minutes. The amount of particle size degradation (i.e., the ball pan hardness number) is determined by measuring the quantity of carbon, by weight, which is retained on a sieve whose openings are closest to one half the openings of the sieve that defines the minimum nominal particle size of the original sample.

“Binder” refers to a material that promotes cohesion of aggregates or particles. Binders are typically solids, semi-solids, or liquids.

“Bioavailability” refers to the extent to which contaminants in soil or sediment are accessible to humans or ecological receptors.

“Carbonaceous” refers to a carbon-containing material, particularly a material that is substantially rich in carbon.

“Circularity”, abbreviated herein as “C”, refers to the ratio of the circumference of an equivalent-area circle (P_{eq}) to the actual perimeter (P) of a particle, C=P_{eq}/P, where 0<C≤1. The circularity is a measure of a particle's roundness. A circle has a circularity equal to 1, while a square has a circularity equal to about 0.89. The circularity of a rectangular particle having a length three times its width is equal to about 0.77.

“Coal” refers to a combustible material formed from prehistoric plant life. Coal includes, without limitation, peat, lignite, sub-bituminous coal, bituminous coal, steam coal, anthracite, and graphite. Chemically, coal is a macromolecular network comprised of groups of polynuclear aromatic rings, to which are attached subordinate rings connected by oxygen, sulfur, and aliphatic bridges.

“Composition” refers to one or more chemical units composed of one or more atoms, such as a molecule, polyatomic ion, chemical compound, coordination complex, coordination compound, and the like. As will be appreciated, a composition can be held together by various types of bonds and/or forces, such as covalent bonds, metallic bonds, coordination bonds, ionic bonds, hydrogen bonds, electrostatic forces (e.g., van der Waal's forces and London's forces), and the like.

“Granulated activated carbon”, abbreviated herein as “GAC”, refers to an adsorbent material derived from carbonaceous raw material, in which thermal or chemical means have been used to remove most of the volatile non-carbon constituents and a portion of the original carbon content, yielding a structure with high surface area. GAC may be granular in form, extruded, or a manufactured agglomerate. The American Society for Testing and Materials (ASTM D5158) classifies GAC as having particle sizes corresponding to larger than an 80-mesh sieve (0.177 mm).

“Hardness” refers to a material's ability to resist mechanical degradation from impact, crushing, and attrition. The hardness may be demined using a ball pan hardness method.

“Iodine number” refers to the milligrams of a 0.02 normal iodine solution adsorbed during a standard test (ASTM D4607). The iodine number is a close measure of the volume present in pores ranging from 1.0 to 2.8 nm in diameter.

“Molasses number” refers to the milligrams of molasses adsorbed during the standard test. The molasses number is an approximate measure of the volume in pores greater than 2.8 nm in diameter.

“Particle size” may refers to the median particle size (D50), unless otherwise specified, which may be measured by sieving according to ASTM D2862 or other methods. The D50 is the maximum particle diameter below which 50% of the sample volume exists, also known as the median particle size by volume. The D90 is the maximum particle diameter below which 90% of the sample volume exists. The D10 is the maximum particle diameter below which 10% of the sample volume exists.

“Particle size distribution”, abbreviated herein as “PSD”, may refer to the range of particle sizes within a sample which is measured by sieving according to ASTM D2862. Two particle size criteria are the effective size, which corresponds to the sieve size through which 10% of the sample volume will pass (D10), and the uniformity coefficient, which is the ratio of the sieve size that will just pass 60% of sample volume to the effective size.

“Pore volume” refers to volume within the carbon particles due to the presence of pores in cubic centimeters per gram (cm³/g). Pore volumes may be measured using gas adsorption techniques (e.g., N₂ adsorption) using instruments such as a TriStar II Surface Area Analyzer (Micromeritics Instruments Corporation, Norcross, Ga., USA).

“Powdered activated carbon”, abbreviated as “PAC”, refers to an adsorbent material derived from a carbonaceous raw material, in which thermal or chemical means have been used to remove most of the volatile non-carbon constituents and a portion of the original carbon content, yielding a structure with high surface area. The American Society for Testing and Materials (ASTM D5158) classifies PAC as having particle sizes corresponding to an 80-mesh sieve (0.177 mm) and smaller.

“Sediment” refers to natural earth materials of all particle sizes including micron-sized clay particles through silt, sand, gravel, rock, and boulders. Aquatic sediments are derived from and composed of natural physical, chemical, and biological components generally related to their watersheds. They are naturally sorted by size through prevalent hydrodynamic conditions.

“Sorbent” refers to a material that sorbs another substance; that is, the material has the capacity or tendency to take it up by sorption.

“Specific gravity” refers to the ratio of the density of a material to the density of water at 4° C.

“Stirring abrasion test” refers to the abrasion test set forth in the AWWA Standard for Activated Carbon (see AWWA B604-74). The stirring abrasion test measures the percentage retention of the average particle size in the carbon after abrading the carbon by the action of a T-shaped stirrer in a specially fabricated abrasion unit.

The terms “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

Every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include both terminal values as well as each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

Unless otherwise indicated, all numbers expressing quantities, dimensions, conditions, ratios, ranges, and so forth used in the specification and claims are to be understood as being modified in all instances by the term “about” or “approximately”. Accordingly, unless otherwise indicated, all numbers expressing quantities, dimensions, conditions, ratios, ranges, and so forth used in the specification and claims may be increased or decreased by approximately 5% to achieve satisfactory results. In addition, all ranges described herein may be reduced to any sub-range or portion of the range.

The use of “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the summary, brief description of the drawings, detailed description, abstract, and claims themselves.

Reference will now be made in detail to particular embodiments of compounds and methods. The disclosed embodiments are not intended to be limiting of the claims.

An aspect of the disclosure relates to particulate sorbent compositions that are particularly suitable for use in the remediation of aquatic sediments, amount other things. The particulate sorbent compositions comprise activated carbon and optionally a binder material and additives. Studies have shown that the particle size of activated carbon has a major influence on its adsorption properties. The kinetics of adsorption increases proportionally to the particle diameter squared. Access to internal sorption sites and overall mass transfer is more effective in powdered activated carbon (PAC) than in granular activated carbon (GAC). Yet, in some applications, the use of GAC is advantageous, particularly in the treatment of energetic or dynamic systems. For example, the treatment of contaminated sediments generally involves dispersing a particulate sorbent material at or near the surface of a body of water and letting the sorbent material sink through the water column and deposit on the surface of the underlying contaminated sediment. However, if the particle size of the sorbent material is too fine and/or the density is too low, the sorbent particles may be carried away by the current or other dynamic forces in the overlying body of water. In this case, some or even all of the sorbent material may be lost (i.e., not be deposited at the intended remediation site). The particulate sorbent compositions disclosed herein can provide a number of advantages, for example in the remediation of contaminated sediments, depending on the particular configuration.

The particulate sorbent compositions disclosed herein are dual-form compositions, meaning that they may be produce in one form but then undergo transformation into a second form. For example, the particulate sorbent compositions may initially be in the form of granules that, under certain conditions, may undergo particle attrition to form smaller-sized particles. In some embodiments, particle attrition may occur because of mechanical action that degrades and/or breaks apart the larger particles into smaller particles. In other embodiments, particle attrition may occur because of the dissolution of a binder material that holds the initial sorbent particle together. In yet other embodiments, particle attrition may occur because of mechanical action and dissolution of a binder material. Thus, the particulate sorbent compositions of the present disclosure may provide benefits in the treatment of contaminated sediments as the sorbent can be efficiently deposited on the surface of the contaminated sediment in granular form, then broken down into smaller sized particles having enhanced adsorption kinetics and/or capacity.

As will be appreciated, the dual-form particulate sorbent composition possesses a number of physical properties (e.g., hardness, abrasion resistance, density, pore volume, specific gravity, etc.), which may be substantially optimized to obtain the desired particle attrition rate and size distribution and beneficial adsorption properties (e.g., pore size distribution). While not wishing to be bound by any particular theory, it is believed that the dual-form particulate sorbent composition is manufactured from a softer carbonaceous feed material, such as subbituminous or lignite coal, compared to harder bituminous coal or coconut shells, under activation conditions (e.g., steam composition, activation temperature, and activation residence time) carefully selected to provide relative micropore and macropore volumes that balance activated carbon hardness (or abrasion resistance) against contaminant removal ability and efficacy (due to relative micropore (<2 nm), mesopore (2-50 nm), and macropore (50 nm) volumes) to provide a highly effective contaminant removal medium particularly beneficial under the variable conditions of manmade and naturally occurring bodies of water, such as oceans, bays, lagoons, marshes, lakes, reservoirs, ponds, impoundments, estuaries, rivers, streams, and other contaminated bodies of water. The dual-form particulate sorbent composition may also be used in water and wastewater (e.g., sewage and industrial effluent) treatment facilities. Surprisingly, these factors may be synergistically balanced to obtain the dual-form particulate sorbent composition and realize the benefits thereof.

The dual-form particulate sorbent composition comprises activated carbon. Typically, the particulate sorbent comprises between about 50 wt. % and about 100 wt. % of activated carbon. In some embodiments, the particulate sorbent comprises typically more than about 50 wt. % and more typically at least about 60 wt. % to typically no more than about 70 wt. %, more typically no more than about 75 wt. %, even more typically no more than about 80 wt. %, even more typically no more than about 85 wt. %, even more typically no more than about 90 wt. %, even more typically no more than about 95 wt. %, even more typically no more than about 97 wt. %, even more typically no more than about 98 wt. %, even more typically no more than about 99 wt. %, and even more typically about 100 wt. %, or any range within any two of these percentages of activated carbon. In some embodiments, the dual-form particulate sorbent composition can consist essentially of activated carbon or is mostly activated carbon. In some embodiments, activated carbon is GAC, preferably in the form of free-flowing granules. The particulate sorbent composition may be produced from a variety of carbonaceous feed material including, but not limited to, coal (e.g., anthracite, bituminous, sub-bituminous, and lignite), coconut shells, wood, cellulose, peat, and petroleum pitch. In some embodiments, the activated carbon may preferably be produced from sub-bituminous coal, lignite, and wood; more preferably, the activated carbon is produced from lignite. In some embodiments, the activated carbon is not produced from anthracite and/or bituminous coal and is substantially, or entirely, free of binders or thermal derivatives thereof. As will be appreciated, bituminous activated carbon (unlike activated carbon manufactured from lignite and subbituminous coal) is comminuted (crushed and/or ground) and reconstituted or agglomerated using a binder before activation. The binder is commonly charred during activation.

In some embodiments, the carbonaceous feed material for the particulate sorbent composition is at least about 50 wt. %, more typically at least about 55 wt. %, more typically at least about 60 wt. %, more typically at least about 65 wt. %, more typically at least about 70 wt. %, more typically at least about 75 wt. %, more typically at least about 80 wt. %, more typically at least about 85 wt. %, more typically at least about 90 wt. %, and even more typically at least about 95 wt. % lignite coal. As will be appreciated, lignite coal typically has a carbon content of about 60-70 wt. % on a dry ash-free basis, an inherent moisture content typically of least about 35% to as high as 75%, and an ash content that typically ranges from about 6-19%, compared with about 6-12% for bituminous coal. As a result, its carbon content on the as-received basis (i.e., containing both inherent moisture and mineral matter) is typically in the range of about 25-35%. The energy content of lignite coal typically ranges from about 10 to 20 MJ/kg (9-17 million BTU per short ton) on a moist, mineral-matter-free basis.

In some embodiments, the carbonaceous feed material for the particulate sorbent composition is at least about 50 wt. %, more typically at least about 55 wt. %, more typically at least about 60 wt. %, more typically at least about 65 wt. %, more typically at least about 70 wt. %, more typically at least about 75 wt. %, more typically at least about 80 wt. %, more typically at least about 85 wt. %, more typically at least about 90 wt. %, and even more typically at least about 95 wt. % subbituminous coal. As will be appreciated, subbituminous coal typically has a carbon content of about 42-52 wt. % on a dry ash-free basis, an inherent moisture content typically of least about 15% to as high as 30%, and an ash content that typically ranges from about 6-17%. As a result, its carbon content on the as-received basis (i.e., containing both inherent moisture and mineral matter) is typically in the range of 45 wt. % to about 55 wt. %. The energy content of subbituminous coal typically is at least about 20 MJ/kg to about 27 MJ/kg (8500 to 12,000 BTU per pound) on a moist, mineral-matter-free basis.

In some embodiments, the activated carbon is not produced from bituminous coal. As will be appreciated, bituminous coal is formed from sub-bituminous coal that is buried deeply enough to be heated to 85° C. (185° F.) or higher. Its thermal and off-gas quality is ranked higher than lignite and sub-bituminous coal, but less than anthracite. Bituminous coal has a fixed carbon content less than 86% (on a dry, mineral-matter-free basis) and the heat content of bituminous coal typically is at least 10,500 Btu/lb (24,400 kJ/kg) of energy on combustion (on a moist, mineral-matter-free basis). Most bituminous coal is an agglomerating coal (i.e., coal that softens when heated, forming a hard, gray, porous coke that resists crushing). Re-agglomerated coal may be formed from bituminous coal by crushing the coal then adding a binder to form a briquette. The briquette may then be crushed, sized, and activated to form an activated carbon. In some embodiments, the activated carbon is not produced from a re-agglomerated coal. In some embodiments, the activated carbon does not comprise a binder or a thermal derivative thereof.

In certain embodiments, the particulate sorbent composition initially (prior to experiencing any significant attrition) comprises mostly GAC. The GAC may be in the form of free-flowing granules. The particulate sorbent composition has a particle size (e.g., D10, D50, D90, mean, and mode size distribution values) of greater than about 80-mesh (0.177 mm), generally between about 0.2 mm to about 5.0 mm. The particle size (e.g., D10, D50, D90, mean, and mode size distribution values) of the particulate sorbent composition may be an 8×30 US mesh (about 0.6 mm to about 2.36 mm), a 12×20 US mesh (about 0.85 mm to about 1.7 mm), a 12×40 US mesh (about 0.42 mm to about 1.7 mm), a 20×50 US mesh (about 0.30 mm to about 0.85 mm), or other suitable mesh sizes. Preferably, the particulate sorbent composition is provided in a 12×40 US mesh, which corresponds typically to a particle size of from about 0.42 mm to about 1.70 mm and more typically of from about 0.50 to about 0.70 mm, and no more than about 4 wt. % typically passes through a 40-mesh sieve and no more than about 5 wt. % is typically retained on a 12-mesh sieve.

In certain other embodiments, the particulate sorbent composition initially (prior to experiencing any significant attrition) comprises smaller particles of activated carbon. In this case, the particulate carbonaceous sorbent composition may be an agglomerate of smaller activated carbon particles held together by a water-soluble binder. The water-soluble binder is added after activation and is therefore not thermally degraded, such as by charring. The agglomerate material may be in the form of extruded granules, for example, it may be provided in an 8×30 US mesh (about 0.6 mm to about 2.36 mm), a 12×20 US mesh (about 0.85 mm to about 1.7 mm), a 12×40 US mesh (about 0.42 mm to about 1.7 mm), a 20×50 US mesh (about 0.30 mm to about 0.85 mm), or other suitable mesh sizes. The water-soluble binder is not particularly limited, but it must be non-toxic, biocompatible, and biodegradable. Suitable water-soluble binders include, but are not limited to, bentonite, guar gum, carboxymethyl cellulose (CMC), hydroxyethyl cellulose (HEC), hydroxypropyl cellulose (HPC), hydroxypropylmethyl cellulose (HPMC), sodium alginate (SA), pectin, xanthan gum, and mixtures thereof. The binder material may be present in an amount ranging typically from about 0.1 wt. % to about 30 wt. %, and more typically from about 1 wt. % to about 10 wt. % of the particulate sorbent composition, and in some embodiments typically a minimum content is about 0.1 wt. %, more typically about 0.5 wt. %, and even more typically about 1 wt. %, and a maximum content is typically about 5 wt. %, more typically about 10 wt. %, even more typically about 15 wt. %, even more typically about 20 wt. %, even more typically about 25 wt. %, and even more typically about 30 wt. %, or any range within any two of these minimum and maximum values.

The size of the activated particles that are included in the particulate sorbent composition may depend upon the specific end-use application (e.g., energetics of the system), and if the particulate sorbent composition comprises a water-soluble binder. The activated carbon, initially (prior to experiencing any significant attrition) may have one or more of a medium particle size (D50), a D10 value, and a D90 value of about 50 μm to about 2,000 μm, and in some embodiments one or more of a D50, a D10, and a D90 of about 50 μm, about 100 μm, about 150 μm, about 200 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1,000 μm, about 1,050 μm, about 1,100 μm, about 1,150 μm, about 1,200 μm, about 1,300 μm, about 1,350 μm, about 1,400 μm, about 1,450 μm, about 1,500 μm, about 1,550 μm, about 1,600 μm, about 1,650 μm, about 1,700 μm, about 1,750 μm, about 1,800 μm, about 1,850 μm, about 1,900 μm, about 1,950 μm, about 2,000 μm, or any range within any two of these values, depending upon the end-use application.

The particulate sorbent composition may be characterized by its mechanical strength, which may vary depending upon the type of starting material and the degree of activation of the material used to form the activated carbon component, among other things. One method of characterizing the mechanical strength of particulate materials is a ball pan hardness value, which is determined according to method described in ASTM D3802. Materials with a higher ball pan hardness number are more resistant to abrasion or attrition. GACs produced commercially are generally made from dense starting materials like bituminous coal, re-agglomerated coal, coconut shells, etc. that provide very strong and hard particles, and generally have a ball pan hardness of between 75-95%. In some embodiments, the particulate sorbent composition of the present disclosure has a ball pan hardness of typically no more than about 75%, more typically about 70% or less, more typically about 65% or less, more typically about 60% or less, more typically about 55% or less, or even more typically about 50% or less. In some embodiments, the particulate sorbent composition typically has a ball pan hardness of between about 40% and about 75%, and in some embodiments a ball pan hardness is about 40%, about 45%, about 50%, about 55%, about 60%, about 65%, about 70%, about 74.5%, or any range within any two of these values. If the particulate sorbent composition has a ball pan value of greater than 75%, the particulate sorbent composition can be too resistant to attrition; it can maintain its size and shape during use and not break down at the treatment site. If the particulate sorbent composition has a ball pan value of less than about 40%, the particulate sorbent composition can be too soft and may breakdown during handling, for example during packing, transporting, and/or dispensing operations.

The particulate sorbent composition may further be characterized by its abrasion number. GACs produced commercially are generally made from dense starting materials like bituminous coal, re-agglomerated coal, coconut shells, etc. that provide very strong and hard particles, and they generally have an abrasion number of between 75 to 97. In some embodiments, the particulate sorbent composition of the present disclosure has an abrasion number of typically less than about 75, more typically about 70 or less, more typically about 65 or less, more typically about 60 or less, more typically about 55 or less, or even more typically about 50 or less. In some embodiments, the particulate sorbent composition typically has abrasion number of between about 40 and about 74.5, more typically between about 50 and 70, and in some embodiments the abrasion number is about 40, about 45, about 50, about 55, about 60, about 65, about 70, about 75, or any range within any two of these values. If the particulate sorbent composition has an abrasion number of greater than about 75, the particulate sorbent composition can be too resistant to attrition; it can maintain its size and shape during use and not break down at the treatment site. If the particulate sorbent composition has an abrasion number value of less than about 40, the particulate sorbent composition can be too soft and may breakdown during handling, for example during packing, transporting, and/or dispensing operations.

The particulate sorbent composition may also be characterized by its apparent density, which may vary depending upon the type of starting material and the degree of activation of the material used to form the activated carbon component, among other things. The particulate sorbent composition typically has an apparent density of between about 0.2 g/cc and about 0.4 g/cc, and in some embodiments an apparent density of about 0.20 g/cc, about 0.21 g/cc, about 0.22 g/cc, about 0.23 g/cc, about 0.24 g/cc, about 0.25 g/cc, about 0.26 g/cc, about 0.27 g/cc, about 0.28 g/cc, about 0.29 g/cc, about 0.30 g/cc, about 0.31 g/cc, about 0.32 g/cc, about 0.33 g/cc, about 0.34 g/cc, about 0.35 g/cc, about 0.36 g/cc, about 0.37 g/cc, about 0.38 g/cc, about 0.39 g/cc, about 0.40 g/cc, or any range within any two of these values. If the particulate sorbent composition has an apparent density of greater than about 0.4 g/cc, the particulate sorbent composition may be too hard and not break down at the treatment site. If particulate sorbent composition has an apparent density of less than about 0.20 g/cc, the particulate sorbent composition may be too soft and breakdown during handling, for example during packing, transporting, and/or dispensing operations.

The particulate sorbent composition may further be characterized by its specific gravity, which may vary depending upon the type of starting material and the degree of activation of the material used to form the activated carbon component, among other things. The particulate sorbent composition has a specific gravity greater than 1, and in some embodiments, a specific gravity of about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, or any range within any two of these values. If the particulate sorbent composition has a specific gravity greater than 2.5, the particulate sorbent composition will likely be too hard and may maintain its size and shape during use. If the particulate sorbent composition has a specific gravity of less than 1, the particulates will not sink cannot be deposited on the sediment surface and/or may be carried away by the current or other dynamic forces in the overlying water body.

The particulate sorbent composition may further be characterized by its pore volume, which may vary depending upon the type of starting material and the degree of activation of the material used to form the activated carbon component, among other things. In one characterization, the particulate sorbent composition has a high pore volume and a well-controlled distribution of pores. The pore sizes can be categorized as being micropores (width <2 nm), mesopores (width=2-50 nm), or macropores (width >50 nm), with the differences in the size of their width openings being a representation of the pore distance. In this regard, the sum of micropore volume, mesopore volume, and macropore volume (i.e., the total pore volume) of the sorbent may be at least about 0.10 cc/g, such as typically at least about 0.20 cc/g, more typically at least about 0.30 cc/g or even more typically at least about 0.60 cc/g. The micropore volume of the sorbent may be at least about 0.10 cc/g, more typically at least about 0.15 cc/g, and in some embodiments, or, in some embodiments, about 0.10 cc/g, typically about 0.15 cc/g, more typically about 0.20 cc/g, or any range within any two of these values. Further, the mesopore volume of the sorbent may be at least about 0.30 cc/g, more typically at least about 0.40 cc/g, or, in some embodiments, about 0.30 cc/g, typically about 0.40 cc/g, more typically about 0.50 cc/g, or any range within any two of these values. In one characterization, the ratio of micropore volume to mesopore volume (micropore volume/mesopore volume) may be at least about 0.2 and no more than about 1.0, in some embodiments, the ratio of micropore volume to mesopore volume is typically about 0.2, more typically about 0.3, more typically about 0.4, more typically about 0.5, more typically about 0.6, more typically about 0.7, more typically about 0.8, more typically about 0.9, or about 1.0, or any range within any two of these values. In another characterization, the ratio of micropore volume to the total volume (micropore volume/total pore volume) may be at least about 0.1 to no more than about 0.5, more typically at least about 0.2 to no more than about 0.4. In some embodiments, the ratio of micropore volume to the total volume is about 0.1, more typically about 0.2, more typically about 0.3, more typically about 0.4, or about 0.5, or any range within any two of these values. In another characterization, the ratio of macropore volume to the total volume (macropore volume/total pore volume) may be at least about 0.5 to about 0.9, more typically about 0.6 to about 0.8. In some embodiments, the ratio of macropore volume to the total volume is typically about 0.5, more typically about 0.6, more typically about 0.7, more typically about 0.8, or about 0.9, or any range within any two of these values. Such levels of micropore and mesopore volumes can advantageously enable efficient capture and sequestration of contaminates by the sorbent while maintaining the structural integrity of the sorbent material. Such levels of micropore and mesopore volumes can advantageously enable efficient capture and sequestration of contaminates by the sorbent while maintaining the structural integrity of the sorbent material. In comparison, GACs produced commercially from dense starting materials, such as bituminous coal, typically have a ratio of micropore volume to total volume of between 0.55 to 0.75 and a ratio of mesopore volume to total volume of between 0.25 to 0.45.

The particulate sorbent composition may further be characterized by its iodine number. The iodine number is an approximate measure of the volume of pores having a width from 1 Tim to 2.8 nm. In some embodiments, the particulate sorbent composition has an iodine number of from about 450 to about 650, more typically between about 475 and about 625, even more typically between about 500 to about 600, and even more typically between about 500 to about 550. In some embodiments, the particulate sorbent composition has an iodine number of about 450, about 475, about 500, about 525, about 550, about 575, about 600, about 625, about 650, about 675, about 700, about 725, about 750, about 775, about 800, or any range within any two of these values. If the iodine number is greater than about 800 then the particulate sorbent composition can contain too high of a fraction of micropores and/or smaller sized mesopores, which may be disadvantageous for the use of the particulate sorbent composition in liquid applications, particularly the capture and sequestration of larger sized contaminates in liquid applications, and the sorbent composition may be too hard or strong to break down in particle size after application to a body of water and thereby fail to provide the target particle size distribution and surface area for effective contaminant removal.

The particulate sorbent composition may further be characterized by its molasses number. The molasses number is an approximate measure of the volume of pores having a width greater than 2.8 nm. In some embodiments, the particulate sorbent composition has a molasses number from about 25 to about 150, more typically between about 30 and about 120, more typically between about 40 to about 100, and even more typically between about 50 to about 85. In some embodiments, the particulate sorbent composition has a molasses number of about 25, about 30, about 35, about 40, about 45, about 50, about 55, about 60, about 65, about 70, about 75, about 80, about 85, about 90, about 95, about 100, about 105, about 110, about 115, about 120, about 125, about 130, about 135, about 140, about 145, about 150, or any range within any two of these values. If the molasses number is greater than about 150 then the particulate sorbent composition typically contains too high a fraction of larger sized mesopores and/or micropores which may compromise the structural integrity and smaller sized contaminant removal of the particulate sorbent composition. If the molasses number is less than about 25 the particulate sorbent composition typically contains too low a fraction of larger sized mesopores which may be disadvantageous for the use of the particulate sorbent composition in liquid applications, particularly the capture and sequestration of larger sized contaminates in liquid applications and may have insufficient abrasion resistance to retain a target size distribution during shipping and handling.

The particulate sorbent composition may further be characterized by its shape. In some embodiments, the sorbent composition may comprise particles that are generally spherical, elliptical, and/or cylindrical. In other embodiments, the sorbent composition may comprise particles that are irregular in shape. Under certain conditions, particles that are irregular in shape may advantageously undergo particle size attrition more readily that more uniform, rounded particles. In one characterization, the particulate sorbent composition has a circularity of less than 1. In some embodiments, the particulate sorbent composition has a circularity from about 0.5 to about 1, more typically between about 0.6 and about 0.9, and more typically between about 0.75 to about 0.85. In some embodiments, the particulate sorbent composition has a circularity of about 0.5, about 0.55, about 0.60, about 0.65, about 0.70, about 0.75, about 0.8, about 0.85, about 0.90, about 0.95, about 1, or any range within any two of these values.

In some embodiments, the particulate sorbent composition may further comprise a mineral content that is inherent or native to the sorbent. In one characterization, the minerals may be intertwined within the sorbent composition. These minerals may include, but not limited to, aluminum-containing minerals, calcium-containing minerals, iron-containing minerals, silicon-containing minerals, sodium-containing minerals, potassium-containing minerals, zinc-containing minerals, tin-containing minerals, magnesium-containing minerals, and combinations thereof. The minerals may predominantly be oxide-based minerals, such as metal oxide minerals (e.g., CaO, Fe₂O₃, Fe₃O₄, FeO, Al₂O₃, etc.), and silicates (e.g., Al₂SiO₅). In certain instances, the mineral content may aid in the capture and sequestration of certain contaminates. In these embodiments, the particulate sorbent composition may comprise at least about 10 wt. % but not greater than about 40 wt. % of minerals, preferably about 20% to 30 wt. % minerals.

In some embodiments, the particulate sorbent composition may further comprise one or more additives or dopants to increase the adsorptivity and/or absorptivity of the particulate sorbent composition to a particular contaminate. For example, activated carbons doped with certain metal oxides may provide for enhanced sorption of PAHs and PCB. In one characterization, the additive may be preferentially dispersed on the surface of the sorbent composition. The additive may comprise a catalytic metal selected from the group consisting of Fe, Cu, Mn, Zn, Pd, Au, Ag, Pt, Ir, V, Ni, Ce, and mixtures thereof. The additive may be in the form of a metal salt, a metal oxide, a metal halide, a metal hydroxide, a metal sulfate, a metal nitrate, a metal carbonate, and combinations thereof. In some embodiments, the catalytic metal compound is selected from the group consisting of copper (II) oxide (CuO), copper (II) chloride (CuCl₂), copper (II) nitrate (Cu(NO₃)₂), copper (II) hydroxide (Cu(OH)₂), copper (II) carbonate (CuCO₃), iron (III) oxide (Fe₂O₃), iron (III) chloride (FeCl₃), iron (III) nitrate (Fe(NO₃)₃), iron (III) sulfate Fe₂(SO₄)₃, cerium (IV) oxide (CeO₂), manganese (IV) oxide (MnO₂), vanadium (V) oxide (V₂O₅), zinc (II) oxide (ZnO) and zinc sulfate (ZnSO₄). In some embodiments, the additive may comprise a halogen or halide, which in some instances may be in the form of a salt. In these embodiments, the particulate sorbent composition may comprise at least about 0.01 wt. % but not greater than about 10 wt. % of the additive, and more typically about 0.1% to about 5 wt. % additives.

In some embodiments, the particulate sorbent composition may comprise one or more additives to improve certain physical properties of the sorbent. For example, in some embodiments, a dispersant may be included to help separate the sorbent particles and prevent their clumping together. The dispersant is not particularly limited other than it must be non-toxic, biocompatible, and biodegradable. An example of a suitable dispersant is an alkali metal (e.g., sodium) lignosulfonate. In some embodiments, a flocculant may be included to promote flocculation or settling of the sorbent particles. The flocculant is not particularly limited other than it must be non-toxic, biocompatible, and biodegradable. An example of a suitable flocculant is chitosan.

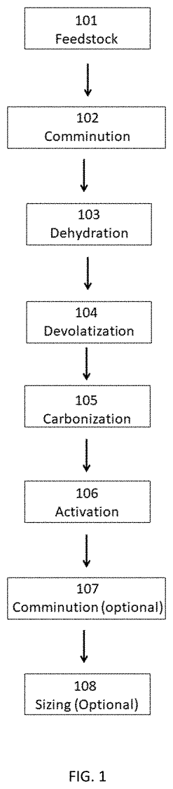

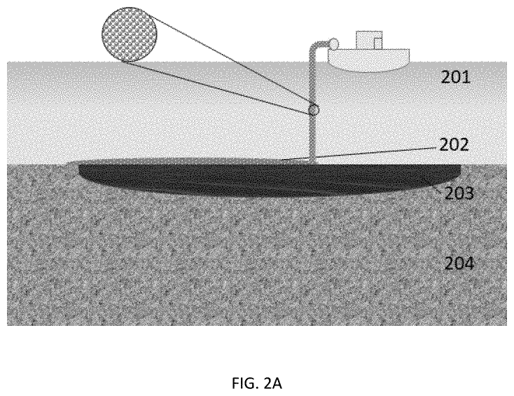

Another aspect of the present disclosure are methods of manufacturing the particulate sorbent composition disclosed herein. FIG. 1 is a flow sheet that illustrates an exemplary method of manufacturing the particulate sorbent composition. The manufacturing process begins with a carbonaceous feedstock 101 such as coal (e.g., lignite), wood, cellulose, or another suitable carbonaceous material. The carbonaceous feedstock 101 is subjected to a comminution step to reduce its mean, median, and modal size. Comminution 101 may occur, for example, in a mill such as a roll mill, jet mill, classifier mill, or other like device. The commuted feedstock 102 is next subjected to an elevated temperature and one or more oxidizing gases under exothermic conditions for a period of time to activate the feedstock 102. The specific steps in the process include: (1) dehydration 103, where the feedstock 103 is heated to remove the free and bound water, typically occurring at temperatures ranging from about 100° C. to about 150° C. (about 212° F. to about 302° F.); (2) devolatilization 104, where free and weakly bound volatile organic constituents are removed, typically occurring at temperatures above about 150° C. (above about 302° F.); (3) carbonization 105, where non-carbon elements continue to be removed and elemental carbon is concentrated and transformed into random amorphous structures, typically occurring at temperatures ranging from 350° C. to 800° C. (about 662° F. to about 1472° F.); and (4) activation 106, where steam, air, or another oxidizing agent is added and pores are developed, typically occurring at temperatures above about 800° C. (above about 1472° F.). The manufacturing process may be carried out, for example, in a multi-hearth or rotary furnace. The manufacturing process is not necessarily discrete and any two or more of the foregoing steps can overlap and/or can use various temperatures, gases, and residence times within each step to promote desired surface chemistry and physical characteristics of the manufactured intermediate particulate carbonaceous material.

As will be appreciated the degree of activation may be varied depending upon the process conditions, for example, the steam to coal ratio (steam/coal) which typically ranges from about 0.1 to about 1.7 and more typically from about 0.25 to about 1.6, the activation residence time which typically ranges from about 2.0 hrs. to about 5.0 hrs., and more typically from about 2.5 hrs. to about 4.0 hrs. in a multi hearth furnace, and the temperature which typically ranges from about 1400° F. to about 1800° F. (about 760° C. to about 982° C.) and more typically from about 1500° F. to about 1650° F. (about 816° C. to about 899° C.). These properties may be used to tune the physical properties of the activated carbon. Typically, higher levels of activation will produce a softer GAC.

In some instances, the activated particulate carbonaceous material 106 may contain agglomerates and may have a median particle size that is too large to be used in the desired sorbent applications. If this is the case, the activated particulate carbonaceous material may optionally be subjected to a second comminution step 107 to reduce the particle size. Additionally, or alternatively, in some instances, the activated particulate carbonaceous material 106 may contain an undesirable number of small particles. If this is the case, a subsequent sizing step 108 may be carried out to reduce the concentration of such very fine particles in the activated particulate sorbent composition. For example, the activated particulate sorbent composition may be subjected to a sizing step 108 that includes removing at least a portion of the fine-sized particles and/or selectively agglomerating at least a portion of the fine-sized particles to form larger sized particles, thereby reducing the concentration of fine-sized particles.

In certain embodiments, the activated carbon particles may be mixed with one or more additives. The addition of additives optionally may occur after activation 106, either before or after a second comminution step 107 or sizing step 108. This may be accomplished by dry admixing, impregnation, or by coating the sorbent with the additive. For example, coating of the sorbent with the additive may be accomplished by first making an aqueous solution or slurry of the additive and then applying the solution directly to the sorbent either by mixing with or spraying onto the sorbent such as in a fluidized bed coater.

In certain embodiments, activated carbon particles may be mixed with a binder to form manufactured agglomerates. The binder material can be contacted with the base material in the presence of water. Suitable water-soluble binders include, but are not limited to, bentonite, guar gum, carboxymethyl cellulose (CMC), hydroxyethyl cellulose (HEC), hydroxypropyl cellulose (HPC), hydroxypropylmethyl cellulose (HPMC), sodium alginate (SA), pectin, and xanthan gum. The binder material can be in the form of an aqueous solution of the binder material. Agglomerates may be formed using large-scale equipment such as rotary pan pelletizers or high shear mixers to mix the binder with the activated carbon. Alternatively, agglomerates may be formed by direct spray of solution of the binding material on the activated carbon followed by drying and mechanical size separation.

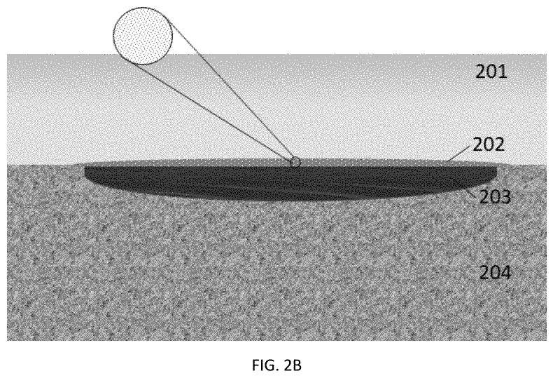

Another aspect of the disclosure relates to methods of remediating contaminated aquatic sediments using the dual function particulate sorbent compositions disclosed herein and active barrier layers formed therefrom. A representative drawing of an embodiment of this process is shown in FIG. 2. In this method, an active barrier layer 202 is formed on the surface of a contaminated sediment 203 to stabilize the sediment, minimize the re-suspension and transport of sediment particles, reduce dissolved contaminant transport into surface waters, and/or to treating sediment-borne contaminants. The contaminated sediment may be located at the bottom of a body of water 201, such as, oceans, bays, lagoons, marsh, lakes, reservoirs, ponds, impoundments, estuaries, rivers, streams, and other contaminated bodies of water. The active barrier layer comprises the dual-form particulate sorbent composition disclosed herein and optionally an inert material and may comprise more than one layer, each layer having a thickness from about 1 inch to a about 1 foot, typically between about 4 to 6 inches.

The method of treating a contaminated aquatic sediment generally comprises, dispersing the dual-form particulate sorbent composition disclosed herein, above the contaminated sediment, typically at or near the surface of a body of water overlying a contaminated sediment. In some embodiments, the particulate sorbent composition may be mixed with or co-dispersed with an inert material, such as sand or gravel. The weight ratio of the particulate sorbent composition to the inert material is, in some embodiments, about 0.1:99.9, about 0.5:99.5, about 1:99, about 2:98, about 3:97, about 4:96, about 5:95, or any range within any two of these ratios. The dispersing may involve dumping, dropping, pouring, and/or sprinkling the particulate sorbent composition, at controlled feed rate, in dried form or it may comprise pumping a slurry of the particulate sorbent composition, at a controlled feed rate, into the body of water. The dispersed particulate sorbent composition sinks through the water column, eventually settling on the surface of the contaminated sediment, forming an active barrier layer over the surface of the contaminated sediment. This process may be repeated one or more times. Once deposited, at least a portion of the particulate sorbent material undergoes particle attrition resulting in the formation of smaller particles. Particle attrition may occur as a result of dynamic forces at or near the sediment surface and/or as a result of mixing with suspended sediment particles or other particles at or near the sediment surface. Additionally, or alternatively, particle attrition may occur due to the dissolution of a water-soluble binder which releases smaller-sized sorbent particles.

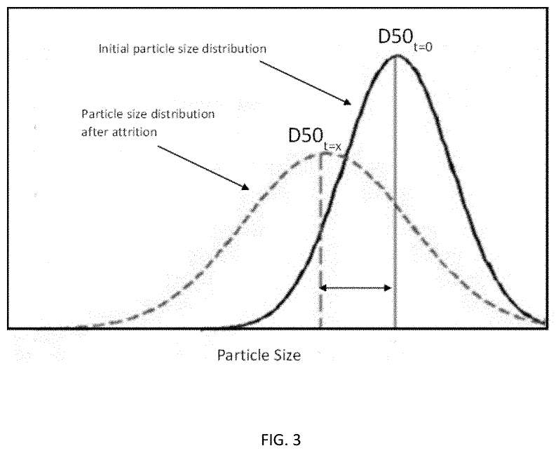

The particulate sorbent composition, preferably, is initially in the form of free-flowing granules. In some embodiments, the granules are 8×30 US mesh (about 0.6 mm to about 2.36 mm), 12×20 US mesh (about 0.85 mm to about 1.7 mm), 12×40 US mesh (about 0.42 mm to about 1.7 mm), 20×50 US mesh (about 0.30 mm to about 0.85 mm), or other suitable mesh sizes. Preferably, the granules have a 12×40 US mesh size or a 20×50 US mesh size. Once deposited, at least a portion of the particulate sorbent composition undergoes particle attrition, shifting the particle size distribution to smaller sizes. This shift is qualitatively shown in FIG. 3. The shift in the particle size distribution to smaller sizes, increases the mass transfer within the pores of the particles, increase the number density, and reduces the average distance between sorbent particles in the active capping layer. These factors lead to an increase in the adsorption capacity of the sorbent material.

The degree of breakdown of the particulate sorbent composition, once deposited, depends upon a variety of factors, including, but not limited to, the particle physical properties such as size, hardness, apparent density, pore volume and distribution, and shape, and also environmental factors such as time, velocity, pressure, shear stress, and temperature. The environmental factors or the hydrodynamics may vary considerably depending on the type of aquatic system, with more energetic systems having the ability to break-down the sorbent particles more efficiently than less energetic system. However, if the system is too energetic, there is the risk that the sorbent particles may be carried away.

The granular sorbent particles may be broken down over time, the time period ranging from days, to weeks, to months, to years. In some embodiments, the granular sorbent composition is broken down, such that the broken-down particle size (D50, D10, and/or D90) is typically less than about 50% of the respective initial particle size (D50, D10, and/or D90, respective), more typically is less than about 40% of the respective initial particle size, more typically is less than about 30% of the respective initial particle size, more typically is less than about 20% of the respective initial particle size, more typically is less than about 10% of the respective initial particle size, more typically is less than 5% of the respective initial particle size, and even more typically is less than about 1% of the respective initial particle size. In some embodiments, the median broken-down particle size (D50) is in the range of about 50 μm to 500 μm, and in some embodiments the median “broken-down” particle size is typically about 50 μm, more typically about 75 μm, more typically about 100 μm, more typically about 125 μm, more typically about 150 μm, more typically about 175 μm, more typically about 200 μm, more typically about 225 μm, more typically about 250 μm, more typically about 275 μm, more typically about 300 μm, more typically about 325 μm, more typically about 350 μm, about 375 μm, more typically about 400 μm, more typically about 425 μm, more typically about 450 μm, more typically about 475 μm, even more typically about 500 μm, or any range within any two of these values.

In another characterization, the particulate sorbent composition has an initial number density. The sorbent composition is broken down into smaller particles such that number density of the broken-down sorbent composition is typically at least about 10 times greater than the initial number density, more typically at least about 100 times greater than the initial number density, more typically at least about 10³ times greater than the initial number density, more typically at least about 10⁴ times greater than the initial number density, more typically at least about 10⁵ times greater than the initial number density, more typically at least about 10⁶ times greater than the initial number density, more typically at least about 10⁷ times greater than the initial number density, more typically at least about 10⁸ times greater than the initial number density, even more typically at least about 10⁹ times greater than the initial number density, or any range within any two of these values.

The breakdown of the particular sorbent material may be characterized using the test protocol set forth in the examples below (see Example 2) or one or more tests such the stirring abrasion test and/or ball pan hardness test. Using one or more of these test methods, in some embodiments, the granular sorbent composition is broken down, such that broken-down particle size (D50, D10, and/or D90) is typically less than about 50% of the respective initial particle size (D50, D10, and/or D90, respectively), more typically is less than about 40% of the respective initial particle size, more typically is less than about 30% of the respective initial particle size, more typically is less than about 20% of the respective initial particle size, more typically is less than about 10% of the respective initial particle size, more typically is less than 5% of the respective initial particle size, and even more typically is less than about 1% of the respective initial particle size. Using one or more of these test methods, in some embodiments, the median broken-down particle size (D50) is in the range of about 50 μm to 500 μm, and in some embodiments the median broken-down particle size is typically about 50 μm, more typically about 75 μm, more typically about 100 μm, more typically about 125 μm, more typically about 150 μm, more typically about 175 μm, more typically about 200 μm, more typically about 225 μm, more typically about 250 μm, more typically about 275 μm, more typically about 300 μm, more typically about 325 μm, more typically about 350 μm, about 375 μm, more typically about 400 μm, more typically about 425 μm, more typically about 450 μm, more typically about 475 μm, even more typically about 500 μm, or any range within any two of these values. Using one or more of these test methods, the sorbent composition is broken down into smaller particles such that number density of the broken-down sorbent composition is typically at least about 10 times greater than the initial number density, more typically at least about 100 times greater than the initial number density, more typically at least about 10³ times greater than the initial number density, more typically at least about 10⁴ times greater than the initial number density, more typically at least about 10⁵ times greater than the initial number density, more typically at least about 10⁶ times greater than the initial number density, more typically at least about 10⁷ times greater than the initial number density, more typically at least about 10⁸ times greater than the initial number density, even more typically at least about 10⁹ times greater than the initial number density, or any range within any two of these values.

Stated differently, the granular sorbent particles have first D10, D50, D90, mean (e.g., number length, surface area moment, or volume moment mean), and mode values and, after the ball pan hardness test and/or stirring abrasion test or the test protocol set forth in the examples below, second D10, D50, D90, mean (e.g., number length, surface area moment, or volume moment mean) and mode values. Each second D10, D50, D90, mean and mode value is typically no more than about 70%, more typically no more than about 65%, more typically no more than about 60%, more typically no more than about 55%, more typically no more than about 50%, more typically no more than about 45%, more typically no more than about 40%, more typically no more than about 35%, more typically no more than about 30%, more typically no more than about 25%, more typically no more than about 20%, more typically no more than about 15%, more typically no more than about 10%, and even more typically no more than about 5% of the first D10, D50, D90, mean and mode value, respectively. As will be appreciated, the D10, D50, D90, mean or mode sizes and other particle size distribution parameters may be determined by any technique including sieve analysis, grid analysis, air elutriation analysis, photoanalysis, optical counting, electro-resistance counting, laser diffraction, dynamic light scattering, electrophoretic light scattering, automated imaging, sedimentation, electrozone sensing, or laser obstruction times. The particle size distribution can be expressed as a number, volume, or intensity weighted distribution.

In embodiments, the particulate sorbent composition treats at least a portion of one or more sediment-borne contaminant, thereby reducing the bioavailability of the one or more sediment-borne contaminant. The active capping layer is permeable or semi-permeable. Sediment-borne contaminants migrate up from the sediment into the active layer whereby they interact with the sorbent material. The mechanism by which the treatment occurs, depends on the nature of contaminant, but generally treatment occurs through the reduction in the contaminant mass, toxicity, solubility and/or mobility. Contaminants can include petroleum products, polychlorinated biphenyls (PCBs), polycyclic aromatic hydrocarbons (PAHs), dioxins, metals (mercury, copper, cadmium, lead, nickel, zinc, tin, etc.), radionuclides, excess nutrients, and combinations thereof.

### EXAMPLES

The following examples are provided to illustrate certain embodiments of the disclosure and are not to be construed as limitations on the disclosure, as set forth in the appended claims.

### Example 1

GACs were produced from lignite coal in a multi hearth furnace under a range of thermal activation conditions and analyzed for ball pan hardness, apparent density, and particle size distribution. GACs A and B were produced using a steam to feed material ratio of 1.26 and a residence time of 3.1 hrs. GACs C and D were produced using a steam to feed material ratio of 1.35 and a residence time of 3.1 hrs.

The physical properties of the various GACs are shown in Table 1. The differences in apparent density and ball pan hardness are the product of the variance in thermal activation conditions (e.g., feed rate, steam level, temperature). Also shown is the ball pan hardness, apparent density, and particle size distribution of a commercial, industry standard bituminous GAC. Notably the lignite coal GACs have a lower apparent density and ball pan hardness compared to the standard bituminous GAC.

TABLE 1
Characterization of GAC properties before and after exposure to the simulated sediment conditions.

| | | | | | | | | % |
|---|---|---|---|---|---|---|---|---|
| | | | | % | % | | GAC post | decrease |
| | | | | passing | increase | | simulated | in average |
| | | | % | 20-mesh | in 20- | Produced | sediment | particle |
| | 12 × 40 | | passing | GAC post | mesh after | GAC | conditions | size after |
| | apparent | 12 × 40 | 20-mesh | simulated | simulated | average | average | simulated |
| | density | ball pan | Produced | sediment | sediment | particle | particle | sediment |
| GAC | (g/cc) | hardness | GAC | conditions | conditions | size (μm) | size (μm) | conditions |
| Industry | 0.52 | 92% | 32% | 34% | 108% | 1060 | 1040 | 2% |
| standard | | | | | | | | |
| bituminous | | | | | | | | |
| GAC | | | | | | | | |
| Lignite | 0.37 | 60% | 33% | 41% | 122% | 1000 | 935 | 7% |
| GAC A | | | | | | | | |
| Lignite | 0.38 | 57% | 39% | 50% | 130% | 950 | 840 | 12% |
| GAC B | | | | | | | | |
| Lignite | 0.36 | 56% | 42% | 65% | 156% | 920 | 685 | 26% |
| GAC C | | | | | | | | |
| Lignite | 0.35 | 55% | 30% | 74% | 244% | 1005 | 620 | 38% |
| GAC D | | | | | | | | |

### Example 2

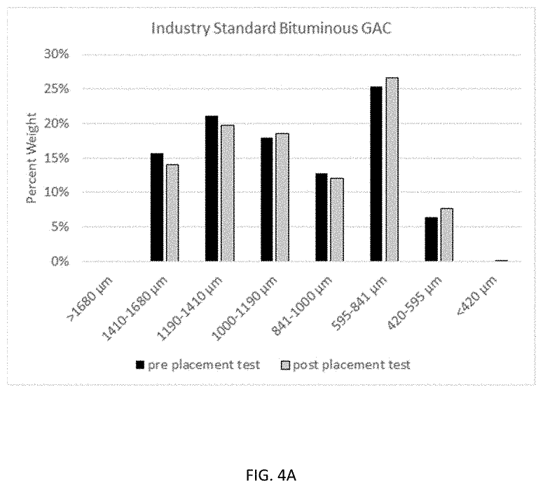

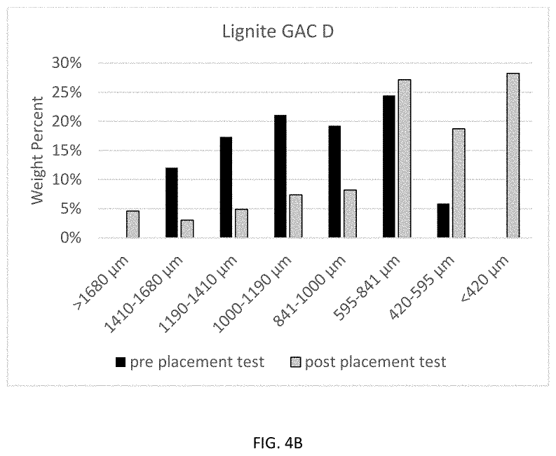

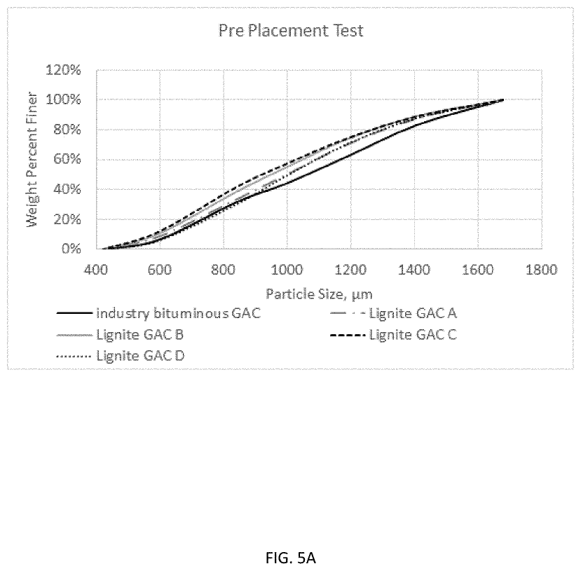

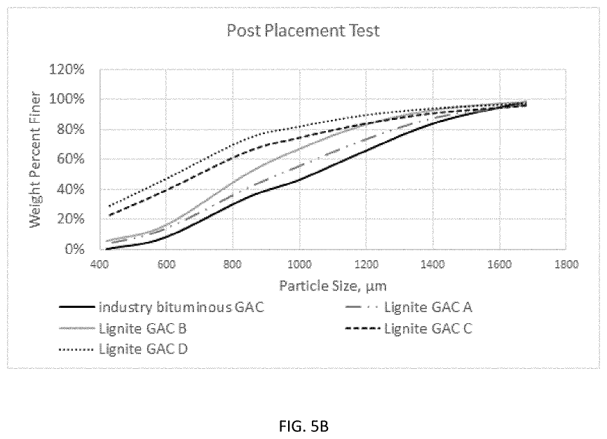

To simulate the process of depositing GAC onto a sediment surface, 30 grams of each GAC, produced in Example 1, was dropped into a 500 mL beaker of water and stirred in a jar testing apparatus at 100 rpm for one hour. The stir paddle was then lowered to just above the surface of the GAC and stirred for 4 days at 40 rpm to simulate mixing on the sediment surface. After the 4 days of exposure to the simulated sediment conditions, the water was decanted and the GAC was dried in an oven at 60° C. overnight. The particle size distribution of the separated GAC was analyzed. The results are shown in FIGS. 4 and 5 and Table 1. The amount of fragmentation that occurred during the simulated sediment conditions was measured by comparing the amount of GAC that passed through a 20 mesh sieve before and after subjecting the GAC to the simulated sediment conditions. The standard bituminous GAC is hard and undergoes very little fragmentation. The lignite based activated carbons are softer and all undergo more fragmentation than the standard bituminous GAC. GAC having a lower ball pan hardness experienced more fragmentation and breakdown during simulated sediment conditions.

### Example 3

A representative active cap was used to illustrate the differences in the characteristics of an active sediment cap that used the industry standard bituminous GAC versus lignite GACs produced according to the methods described herein. The representative active cap consists of 0.1 wt % activated carbon mixed into a 3-inch layer of sand. The extent of fragmentation of the two GACs was taken from the simulated placement test described in Example 2. Upon placement, the increased fragmentation of the lignite GAC meant that the number of lignite GAC particles increases by three orders of magnitude while there was an inconsequential increase in the number of standard bituminous GAC particles. If even the distribution of GAC particles in the 3-inch cap is assumed, the increased number of lignite GAC particles equates to a much smaller average distance between particles compared to the standard bituminous GAC. The chances that a contaminant diffusing up through the active barrier layer bypasses the activated carbon dispersed in the representative active layer is approximated by dividing the average separation distance by the height of the reactive cap. The 8.5% chance that activated carbon is bypassed in the active layer with bituminous GAC compared to a 0.7% chance for lignite GAC illustrates the benefits in particle distribution gained using a soft GAC product in this application.

TABLE 2
Comparing particle dispersion within an active treatment layer.

| | Standard | Lignite |
|---|---|---|
| Characteristic | bituminous GAC | GAC A |
| # of particles per lb. of produced GAC | 1.2E6 | 1.4E6 |
| # of particles per lb. of GAC post placement simulation | 1.3E6 | 3.6E9 |
| Mean separation distance between carbon | 6.5 mm | 0.5 mm |
| particles (mm) in active treatment layer | | |
| Approximate percent chance flow streamline does not | 8.5% | 0.7% |
| contact a carbon particle in a 3-inch sand/carbon | | |
| active treatment layer containing 0.1% carbon | | |

A number of variations and modifications of the disclosure can be used. It would be possible to provide for some features of the disclosure without providing others. The present disclosure, in various embodiments, configurations, or aspects, includes components, methods, processes, systems and/or apparatus substantially as depicted and described herein, including various embodiments, configurations, aspects, subcombinations, and subsets thereof. Those of skill in the art will understand how to make and use the present disclosure after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing detailed description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this detailed description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method of treating contaminated sediments, comprising:
providing a dual-form particulate sorbent composition comprising activated carbon, wherein the particulate sorbent composition is in the form of granules having a first particle size distribution with a first medium particle size distribution defined by first D10, D50, D90, mean, and mode values; and
dispersing the dual-form particulate sorbent composition at or near the surface of a body of water overlaying a contaminated sediment,
wherein:
the dispersed particulate sorbent composition sinks and forms an active barrier layer over at least part of a surface of the contaminated sediment,
the particulate sorbent composition that is contained in the active barrier layer undergoes particle attrition resulting in a second particle size distribution defined by second D10, D50, D90, mean, and mode values, each second D10, D50, D90, mean, and mode value is no more than about 50% of each first D10, D50, D90, mean, and mode value, respectively, and
the particulate sorbent composition in the active barrier layer traps and/or sequesters at least a portion of one or more sediment-borne contaminates.

2. The method of claim 1, wherein the dual-form particulate sorbent composition comprises more than about 50 wt. % activated carbon, wherein at least most of the activated carbon has a ball pan hardness value of no more than about 75% and at least about 40%, an apparent density ranging from about 0.2 g/cc to about 0.4 g/cc, a specific gravity of greater than 1, an iodine number ranging from about 450 to about 650, and a molasses number ranging from about 25 to about 150, wherein the first D50 value ranges from about 0.42 mm to about 1.7 mm, wherein the dual-form particulate sorbent is substantially free of a binder and thermal derivative thereof, and further comprising:
mixing the particulate sorbent composition compositions with an inert material prior to the dispersing.

3. The method of claim 1, wherein at least most of the particulate sorbent composition has a ball pan hardness of between about 40% and 70% and an abrasion number ranging from about 40 to about 70.

4. The method of claim 1, wherein at least most of the particulate sorbent composition has an apparent density of between about 0.2 g/cc and 0.4 g/cc and comprises and from about 0.1 wt. % to about 30 wt. % of a water-soluble binder.

5. The method of claim 1, wherein at least most of the activated carbon is produced from sub-bituminous coal, lignite coal, or wood and wherein at least most of the activated carbon has a ratio of micropore volume to total pore volume ranging from about 0.2 to about 0.4 and ratio of macropore volume to total pore volume ranging from about 0.6 to about 0.8.

6. The method of claim 5, wherein the activated carbon is produced essentially from lignite coal and wherein the particulate sorbent comprises one or more of a dopant to increase an ability of the particulate sorbent to adsorb a selected contaminant, a dispersant, and a flocculant.

7. The method of claim 1, wherein the dual-form particulate sorbent composition comprises more than about 50 wt. % activated carbon, wherein at least most of the activated carbon has a ball pan hardness value of no more than about 75% and at least about 40%, an apparent density ranging from about 0.2 g/cc to about 0.4 g/cc, a specific gravity of greater than 1, an iodine number ranging from about 450 to about 650, and a molasses number ranging from about 25 to about 150, and wherein the first particle size distribution is a 12×40 mesh size or a 20×50 mesh size.

8. The method of claim 1, wherein the particulate sorbent composition further comprises a water-soluble binder material, and wherein at least a portion of the water-soluble binder material dissolves in the body of water resulting in the particle attrition.

9. The method of claim 1, wherein the particle attrition is due to mechanical action at or near the surface of the contaminated sediment, wherein the contaminated sediment is located at the bottom of a lake, a river, a stream, or an estuary, wherein the active barrier has a thickness from about 1 inch to about 6 inches, and wherein the sediment-born contaminate is selected from the group consisting of petroleum products, polychlorinated biphenyls (PCBs), polycyclic aromatic hydrocarbon (PAHs), dioxins, metals, radionuclides, excess nutrients, and a combination thereof.

10. A method of treating contaminated sediments, comprising:
providing a dual-form particulate sorbent composition comprising activated carbon, wherein at least about 75% of the activated carbon is in the form of granules having a ball pan hardness of at least about 40% and no more than about 70%, an iodine number ranging from about 450 to about 650, and a molasses number ranging from about 25 to about 150; and
dispersing the dual-form particulate sorbent composition at or near the surface of a body of water overlaying a contaminated sediment,
wherein:
the dispersed particulate sorbent composition sinks and forms an active barrier layer over at least part of a surface of the contaminated sediment, and
the particulate sorbent composition in the active barrier layer traps and/or sequesters at least a portion of one or more sediment-borne contaminates.

11. The method of claim 10, wherein the particulate sorbent composition is in the form of granules having a first particle size distribution with a first medium particle size distribution defined by first D10, D50, D90, mean, and mode values, wherein the particulate sorbent composition that is contained in the active barrier layer undergoes particle attrition resulting in a second particle size distribution defined by second D10, D50, D90, mean, and mode values, each second D10, D50, D90, mean, and mode value being no more than about 50% of each first D10, D50, D90, mean, and mode value, respectively, wherein the dual-form particulate sorbent composition comprises more than about 50 wt. % activated carbon, wherein at least most of the activated carbon has an apparent density ranging from about 0.2 g/cc to about 0.4 g/cc, a specific gravity of greater than 1, wherein the first D50 value ranges from about 0.42 to about 1.7 mm, wherein the dual-form particulate sorbent is substantially free of a binder and thermal derivative thereof, and further comprising:
mixing the particulate sorbent composition compositions with an inert material prior to the dispersing.

12. The method of claim 10, wherein at about 90% of the activated carbon has a ball pan hardness of between about 40% and 70%, an iodine number ranging from about 475 to about 625, and a molasses number ranging from about 30 to about 120.

13. The method of claim 10, wherein at least most of the particulate sorbent composition has an apparent density of between about 0.2 g/cc and 0.4 g/cc and comprises from about 0.1 wt. % to about 30 wt. % of a water-soluble binder.

14. The method of claim 10, wherein at least most of the activated carbon is produced from sub-bituminous coal, lignite coal, or wood and wherein at least most of the activated carbon has a ratio of micropore volume to total pore volume ranging from about 0.2 to about 0.4 and ratio of macropore volume to total pore volume ranging from about 0.6 to about 0.8.

15. The method of claim 14, wherein the activated carbon is produced essentially from lignite coal and wherein the particulate sorbent comprises one or more of a dopant to increase an ability of the particulate sorbent to adsorb a selected contaminant, a dispersant, and a flocculant.

16. The method of claim 10, wherein the dual-form particulate sorbent composition comprises more than about 75 wt. % activated carbon, wherein at least most of the activated carbon has a ball pan hardness value of no more than about 65% and at least about 45%, an apparent density ranging from about 0.2 g/cc to about 0.4 g/cc, a specific gravity of greater than 1, an iodine number ranging from about 475 to about 625, and a molasses number ranging from about 30 to about 120, and wherein the first particle size distribution is a 12×40 mesh size or a 20×50 mesh size.

17. The method of claim 10, wherein the particulate sorbent composition further comprises a water-soluble binder material, wherein at least a portion of the water-soluble binder material dissolves in the body of water resulting in the particle attrition.

18. A particulate sorbent composition comprising more than about 50 wt. % of an activated carbon, wherein at least most of the activated carbon is in the form of free flowing granules having a ball pan hardness of at least about 40% and no more than about 70%, a D50 size ranging from about 50 μm to about 2,000 μm, an apparent density of at least about 0.2 g/cc and no more than about 0.4 g/cc, an iodine number of at least about 450 and no more than about 650, and a molasses number of at least about 25 to about 150, and a specific density of more than 1.

19. The particulate sorbent composition of claim 18, wherein at least most of the activated carbon has a ratio of micropore volume to total pore volume ranging from about 0.2 to about 0.4, a ratio of macropore volume to total pore volume ranging from about 0.6 to about 0.8, and a D10 size ranging from about 50 μm to about 2,000 μm.

20. The particulate sorbent composition of claim 19, wherein at least about 75% of the activated carbon has a ratio of micropore volume to total pore volume ranging from about 0.2 to about 0.4, a ratio of macropore volume to total pore volume ranging from about 0.6 to about 0.8, and a D90 size ranging from about 50 μm to about 2,000 μm.
